(19) United States
(12) Patent Application Publication
(10) Pub. No.: US 2012/0212486 A1
(43) Pub. Date: Aug. 23, 2012

(54) AUTOSTEREOSCOPIC DISPLAY DEVICE

(75) Inventors: Jan Van Der Horst, Eindhoven (NL); Henricus Joseph Cornelus Kuijpers, Haler (NL)

(73) Assignee: KONINKLIJKE PHILIPS ELECTRONICS N.V., Eindhoven (NL)

(21) Appl. No.: 13/504,992

(22) PCT Filed: Oct. 27, 2010
(86) PCT No.: PCT/IB10/54857

§ 371 Date: Apr. 30, 2012

(30) Foreign Application Priority Data
Nov. 3, 2009 (EP) 09174882.3

(51) Int. Cl. G06T 15/00

(52) U.S. Cl. 345/419

(57) ABSTRACT

An autostereoscopic display device has the display output provided over at least two sub-frames, with different pixel elements operated in the different sub-frames. In this way, a higher resolution or increased number of views is built up in a time-sequential manner.

### FIELD OF THE INVENTION

This invention relates to an autostereoscopic display device of the type that comprises a display panel having an array of display pixels for producing a display and an imaging arrangement for directing different views to different spatial positions.

### BACKGROUND OF THE INVENTION

A display according to the preamble that uses a lenticular (lens) arrangement as the imaging arrangement is known from U.S. Pat. No. 6,064,424. The disclosed display has an array of elongate lenticular elements extending parallel to one another and overlying the display pixel array, and the display pixels are observed by a viewer through these lenticular elements.

The lenticular elements are provided as a sheet of elements, each of which comprises an elongate semi-cylindrical lens element. The lenticular elements extend mainly in the column direction of the display panel, with each lenticular element overlying a respective group of two or more adjacent columns of display pixels.

In an arrangement in which, for example, each lenticule is associated with two columns of display pixels, the display pixels in each column provide a vertical slice of a respective two dimensional sub-image. The lenticular sheet directs these two slices and corresponding slices from the display pixel columns associated with the other lenticules, to the left and right eyes of a user positioned in front of the sheet, so that the user observes a single stereoscopic image. The sheet of lenticular elements thus provides a light output directing function.

In other arrangements, each lenticule is associated with a group of four or more adjacent display pixels in the row direction. Corresponding columns of display pixels in each group are arranged appropriately to provide a vertical slice from a respective two dimensional sub-image. As a user's head is moved from left to right across the display, a series of successive, different, stereoscopic views are perceived creating, for example, a look-around impression.

The above described device provides an effective three dimensional display. However, it will be appreciated that, in order to provide stereoscopic views, there is a necessary sacrifice in the resolution as multiple pixel elements are needed to create a three dimensional pixel. This sacrifice in resolution is a problem for certain applications, such as the display of small text characters for viewing from short distances. For this reason, it has been proposed to provide a display device that is switchable between a two-dimensional mode and a three-dimensional (stereoscopic) mode.

One way to implement this is to provide an electrically switchable lenticular array as disclosed in U.S. Pat,. No. 6,069,650. In the two-dimensional mode, the lenticular elements of the switchable device operate in a “pass through” mode, i.e. they act in the same way as would a planar sheet of optically transparent material. The resulting display has a high resolution, equal to the native resolution of the display panel, which is suitable for the display of small text characters from short viewing distances. The two-dimensional display mode cannot provide a stereoscopic image.

The loss of resolution is also there for the 3D mode. On the one hand a large number of views per angle are needed for a good 3D impression and on the other hand a small number of views are needed for a sufficiently high resolution (i.e. number of pixels) per view.

It has been proposed in WO 2007/072330 to increase the resolution per view by providing an imaging arrangement which is electrically switchable between at least two 3D modes, wherein the effective position of the imaging arrangement is shifted laterally between the modes with respect to the display pixel elements by an amount which is a non-integer multiple of the pitch between the pixel elements.

These two modes enable the resolution per mode to be increased, by adding views at inter-pixel locations, or enable the number of views to be increased. This enables the loss of performance resulting from the generation of 3D images to be reduced. The amount of shift may for example comprise half the pitch between the pixel elements.

This proposed solution gives rise to a complicated imaging arrangement that requires switching between the two 3D modes.

### SUMMARY OF THE INVENTION

It is an object of the invention to provide an autostereoscopic display device with improved resolution.

The invention is defined by the independent claims. The dependent claims define advantageous embodiments.

According to the invention, there is provided an autostereoscopic display device and a method of operating a display device. In the device and method time-multiplexing of sub-frames with different output information necessary for creating stereoscopic view of a frame comprising the sub-frames is combined with the use of different groups of sub-pixels for creating the sub-frames. In other words in one frame of a display output that can be stereoscopically viewed, the information for the left and right eye is provided in at least two sub frames that are output sequentially in time. The time multiplexing also means that control lines for driving the pixels can be shared. This enables a simpler implementation of the display wiring.

The terms pixels and sub-pixels have their usual meaning in the art where a color pixel is able to provide all colors of the display. A sub-pixel may be any primary color such as red green or blue. The pixel may have an additional sub-pixel that is white. Pixels may be e.g. conventional triplets of neighboring sub-pixels, or may be multiprimari having more than three sub-pixels among which one or more are of the same primary color. All sub-pixels preferably have the same shape and size, but this need not be the case.

The imaging arrangement may be an array of display output light barriers in the form of an array of transparent slits positioned in front of the display panel. Alternatively and preferably the imaging arrangement is an array of lenticulars also known as lenticular elements. The slits and lenticulars are for example designed for directing light from the odd and even sub-pixel columns towards the different spatial positions. For example the slits or lenticulars may be sized and positioned in relation to the underlying pixels of the display in order that the output of the sub-pixels is directed to the left and right eye of a viewer in a certain spatial position at the viewing side of the autostereoscopic display.

The imaging arrangement may be switchable between an imaging mode for providing the autostereoscopic capability of the display and a non imaging mode for providing the autostereoscopic display with a mode in which it is capable of displaying a two dimensional image. Examples of such switchable imaging arrangements are in the form of a switchable lenticular array as disclosed in U.S. Pat,. No. 6,069,650, a switchable polarizer in combination with a birefringent lenticular as disclosed in international publication WO03/015424, or a switchable barrier based on for example a liquid crystal light modulator as disclosed in Proceedings of the SPIE, Volume 7329, pp. 732903-732903-8 (2009).

A frame is meant to represent a single image or one of the many single images in a motion picture. The individual frames are built up form sub-frames displayed at least partly in sequence. The Frame rate, or frame frequency, is the measurement of the frequency (rate) at which the display produces the frames. Frame rate is expressed in frames per second (FPS) and in progressive-scan monitors as hertz (Hz). In a still image the display may output a same frame while in a video output different frames may be output that together form the video output.

Preferably, the first and second sub-frames each include information for both eyes of the viewer simultaneously. In this arrangement, each sub-frame provides a full stereoscopic pair of images of a frame so that the two stereoscopic views are seen at the same time. This may avoid image artefacts which may otherwise result if the view for one eye is presented at a different time than the view for the other eye is presented and the difference is too long for the human eye and brain to synthesize the full stereoscopic image.

By dividing the frame into sub-frames and the corresponding frame time into sub frame times, the resolution can be built up in a sequence. The same data lines can be used to address the sub-pixels of the first and second sets so that the display wiring does not need to become more complicated. For example, each column (data line) can be connected to sub-pixels from both sets.

Preferably, the first sub-frame and the second sub-frame together define a complete frame for a display output to be viewed as one set of autostereoscopic images. In this way, the frame is divided into two lower resolution sub-frames.

The first and second sets of sub-pixels can together comprise all the sub-pixels, and no sub-pixel is in both the first and second sets. This means there are non-overlapping patterns of sub-pixels, for example opposite checkerboard patterns defining the two sub-frames.

The sub-pixels can be grouped into color pixels, each color pixel comprising at least two red sub-pixels, or at least two green sub-pixels or at least two blue sub-pixels. Thus, half of the sub-pixels of a color pixel are driven in one sub-frame, and the other half of the sub-pixels of a color pixel are driven in the other sub-frame.

The sub frames can be driven at a rate of 100 Hz, or at higher frequency.

The imaging arrangement preferably comprises an array of lenticulars. The pitch between the lenticulars may correspond to the pitch of an ensemble of five neighboring sub-pixels measured in the row direction.

The lenticulars preferably have a semi cylindrical shape with an elongate axis perpendicular to the curvature of the lenticular where the elongate axis is slanted to the column direction of the display panel which normally is the same as the vertical direction. Note that in displays with portrait and landscape mode, the column direction in the landscape mode is horizontal in the portrait mode. For example slant can be at an angle a where e.g. tan α=⅓, or ⅙. However, other slant angles can be used as disclosed in U.S. Pat. No. 6,064,424 or EP 1566683. A desired slant angle will depend on the pitch between lenses.

The display panel can comprise an array of individually addressable emissive, transmissive, refractive and/or diffractive display pixels. For example, the display panel can be a liquid crystal display panel having transmissive pixels in combination with backlight. Alternatively, the display panel can be a light emitting diode (LED) based display such as an organic light emitting diode (OLED) display panel, or a plasma display panel. The LED, OLED or plasma display panels may have fast sub-pixel response when compared to liquid crystal display panels enabling faster and/or more sub-frames per image frame displayed according to the invention.

### BRIEF DESCRIPTION OF THE DRAWINGS

Embodiments of the invention will now be described, purely by way of example, with reference to the accompanying drawings, in which:

FIG. 1 is a schematic perspective view of a known autostereoscopic display device;

FIG. 2 shows how a lenticular array provides different views to different spatial locations;

FIG. 3 is used to explain the benefit of a slanted focusing arrangement;

FIG. 4 shows a sub-pixel configuration suitable for use in the device of the invention;

FIG. 5 shows how the sub-pixel configuration of FIG. 4 is used to implement the invention;

FIG. 6 shows one possible arrangement for driving the rows and columns of sub-pixels; and

FIG. 7 shows an alternative slanted focusing arrangement;

### DETAILED DESCRIPTION OF EMBODIMENTS

The invention provides an autostereoscopic display in which the display output is provided within at least two sub-frames of a frame, a first sub-frame of a frame being displayed with a set of pixels that is different from the set with which the second sub-frame is displayed. In this way the pairs of images comprising images for the left and right eyes of a viewer, which together form a stereoscopic image are provided within one frame of display output while a higher resolution of the stereo image is obtained via time sequential build up of the frame over at least two sub-frames that are output time-sequentially.

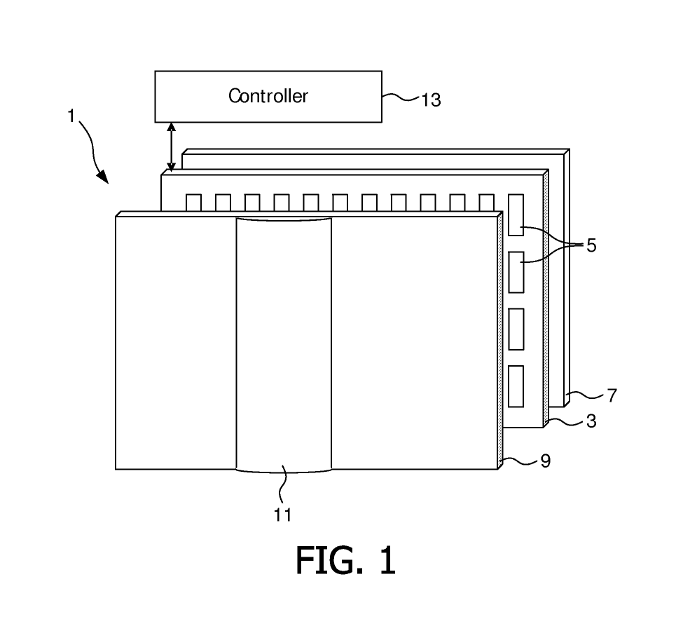

FIG. 1 is a schematic perspective view of a known autostereoscopic display device 1. The known device 1 comprises a liquid crystal display panel 3 of the active matrix type that acts as a spatial light modulator to produce the display.

The display panel 3 has an orthogonal array of display pixels arranged in rows and columns. Each display pixel is composed of three primary color sub-pixels 5; one being red, another green and another blue. For the sake of clarity, only a small number of display pixels are shown. In practice, the display panel 3 might comprise about one thousand rows and several thousand columns of display pixels. In this particular case a display pixel is thus a color pixel consisting of triplets of neighboring sub-pixels 5 and each color pixel has a red, green and blue rectangular sub-pixel. As such, the sub-pixels are also arranged in rows and columns.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarizing layers are also provided on the outer surfaces of the substrates.

Each display pixel 5 comprises electrodes on the substrates, with the intervening liquid crystal material therebetween. The shape and layout of the display pixels 5 are determined by the shape and layout of the electrodes. The display pixels 5 are regularly spaced from one another by gaps, the gaps bring black mask of the display panel.

Each display sub-pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display sub-pixels 5 being driven to modulate the light and produce the display.

The display device 1 also comprises a lenticular sheet 9, arranged over the display side of the display panel 3, which performs a view forming function. The lenticular sheet 9 comprises a row of lenticular elements 11 extending parallel to one another, of which only one is shown with exaggerated dimensions for the sake of clarity.

The lenticular elements 11 are in the form of convex semi-cylindrical lenses, and they act as a light output directing means to provide different images, or views, from the display panel 3 to the eyes of a user positioned in front of the display device 1.

FIG. 1 also shows schematically a controller 13 for driving the display device.

The autostereoscopic display device 1 shown in FIG. 1 is capable of providing several different perspective views in different directions. In particular, each lenticular element 11 overlies a small group of display sub-pixels 5 in each row. The lenticular element 11 projects each display sub-pixel 5 of a group in a different direction, so as to form the several different views. As the user's head moves from left to right, his/her eyes will receive different ones of the several views, in turn. A more detailed operation of view assignment is provided in U.S. Pat. No. 6,064,424.

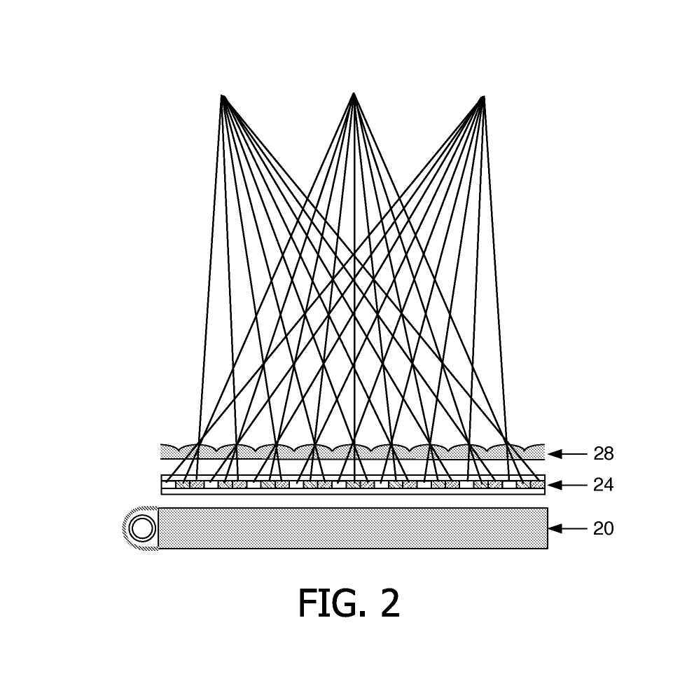

FIG. 2 shows the principle of operation of a lenticular type imaging arrangement as described above and shows the backlight 20, display device 24 such as an LCD and the lenticular array 28. FIG. 2 shows how the lenticular arrangement 58 directs the outputs of different sub-pixels within a subgroup of sub-pixels to different spatial locations.

The present invention provides mechanisms for increasing the resolution per view or increasing the number of views at a given resolution.

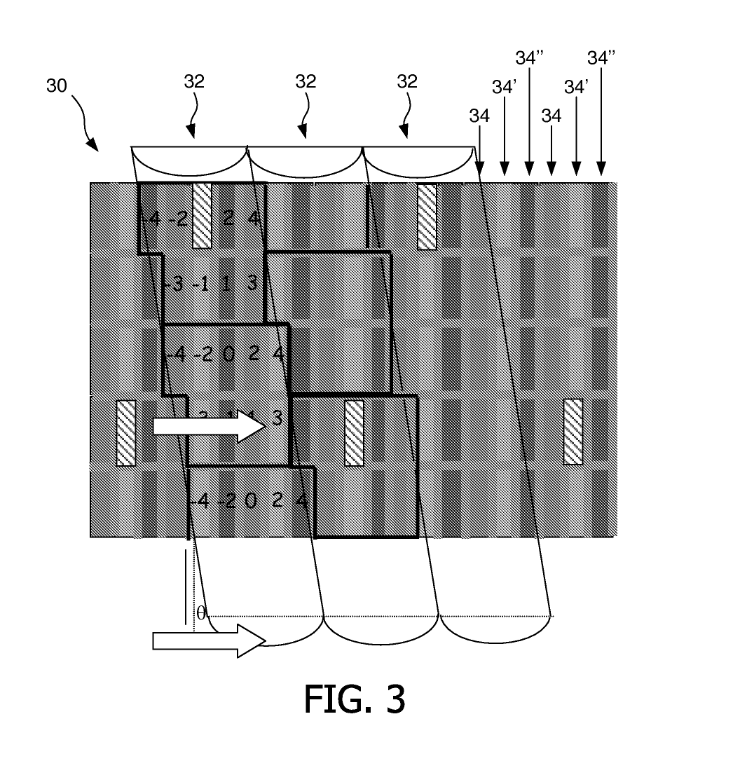

By way of example, FIG. 3 shows the sub-pixel layout of a 9-view display 30, and which uses an array of slanted lenticulars 32. The columns are arranged as columns of red (34), green (34′) and blue (34″) sub-pixels in sequence, and three overlying lenticulars 32 are shown. The numbers shown refer to the view number which the sub-pixels contribute to, with the views numbered from −4 to +4, with view 0 along the lenticulars elongate axis. When the aspect ratio (width: height) of the sub-pixels is 1:3 as in this example, such that each pixel comprises a row of three sub-pixels with a so called RGB configuration, one possible and preferred slant angle of the lenticulars' long axis with respect to the column direction is tan(θ)=⅙. As a result, the perceived resolution loss per view (compared to the 2D case) is a factor of 3 in both the horizontal and vertical direction instead of a factor of 9 in the horizontal direction when the slant angle theta is zero. This arrangement has a lenticular width of 4.5 sub-pixels, or the pitch of the lenticular is equal to the spacing of 4.5 neighboring sub-pixels in the row direction.

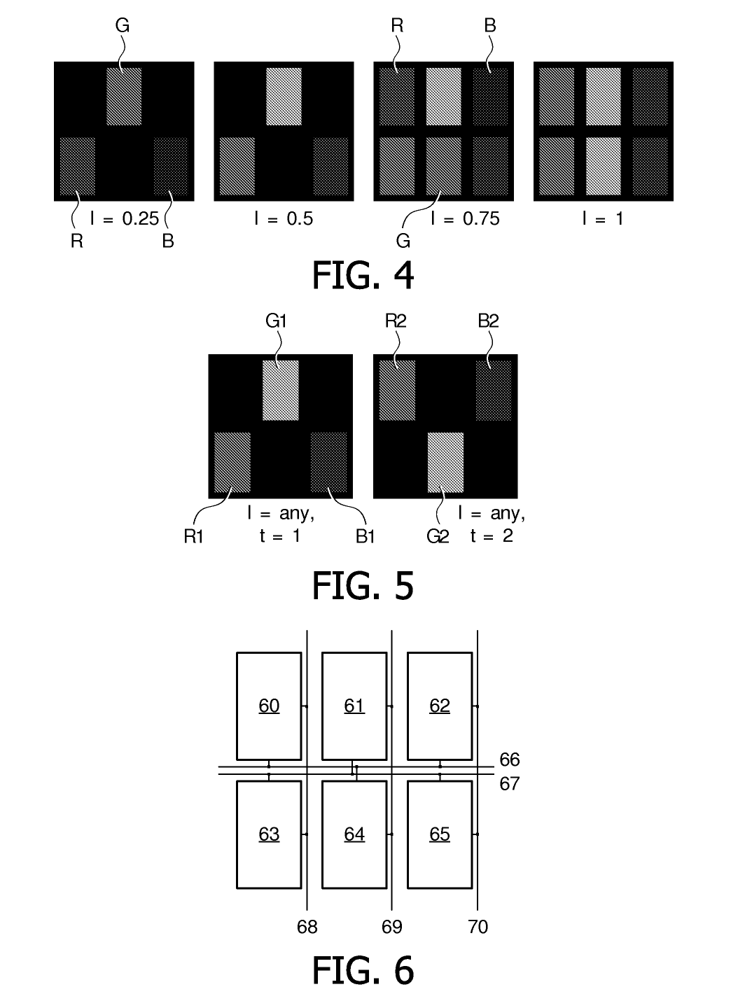

The invention is of particular interest for implementation using a known panel design in which sub-pixels of an RGB color pixel are built up by a spatially separated lower and higher half such as represented in FIG. 4.

Each half has three sub-pixels of red (R) green (G) and blue (B), as shown in FIG. 4. The sub-pixels are controlled to provide four different intensity levels.

For lower intensity levels I (1=0.25 and I=0.5) only one sub-pixel of each color is used. This means that those sub-pixels can be operated at higher brightness than if there were only three sub pixels.

For higher intensities (I=0.75 and I=1), all six sub-pixels are used. The way the different levels are combined takes account of viewing angle performance and gamma stability. In particular, this six sub-pixel arrangement has been devised to improve angle performance of a 2D display. The arrangement does not require the pairs of sub-pixels in each column to be drivable to different non-zero voltages; hence they share the column data line.

An implementation of the invention using the pixel arrangement of FIG. 4 enables the number of views to be doubled at full resolution (i.e. the same pixel pitch, where each pixel is the group of six sub-pixels as shown), without increasing the panel resolution and the required electronics of the panel.

The invention provides driving of the sub-pixels in sub-frames. For the example two triplets of sub-pixels per pixel, i.e. half of the sub-pixels are driven in one sub-frame and the other half of the sub-pixels are driven in the next sub-frame. In this way, a high frame rate and high intensity of the display are used to enable a higher (vertical) resolution in the pixel column direction to be achieved.

In a lenticular or barrier based system, the amount of views is now doubled. Choosing a low crosstalk lens will result in acceptable crosstalk per new view. The invention combines interlacing of images combined with an autostereoscopic imaging arrangement, such as a lenticular lens array.

FIG. 5 shows how the sub-pixel configuration of FIG. 4 can be used to present two different images.

The sub-pixels are driven as checkerboard patterns. A first group of sub-pixels R1, G1 and B1 is driven during a first sub-frame time to provide the first sub-frame and then a second group of sub-pixels R1, G1 and B1 is driven during the second sub-frame time for providing the second sub-frame. Preferably a frame is driven with a frequency of 100 Hz or more. In this way, each sub-frame or group of sub-pixels is updated at 50 frames per second or more, but shifted in time by 1/100 seconds or less for a faster display, i.e. with a refresh rate of higher than 100 Hz.

Although all sub-pixels can now be driven to independent voltage levels, by means of the time interlacing, only three column lines are required per color pixel. Thus, the complexity of the display panel wiring does not need to be increased to enable implementation of the invention. The invention can thus be implemented with existing technology as for example known for liquid crystal displays.

The way the sub-pixels are refreshed sequentially can be achieved in different ways.

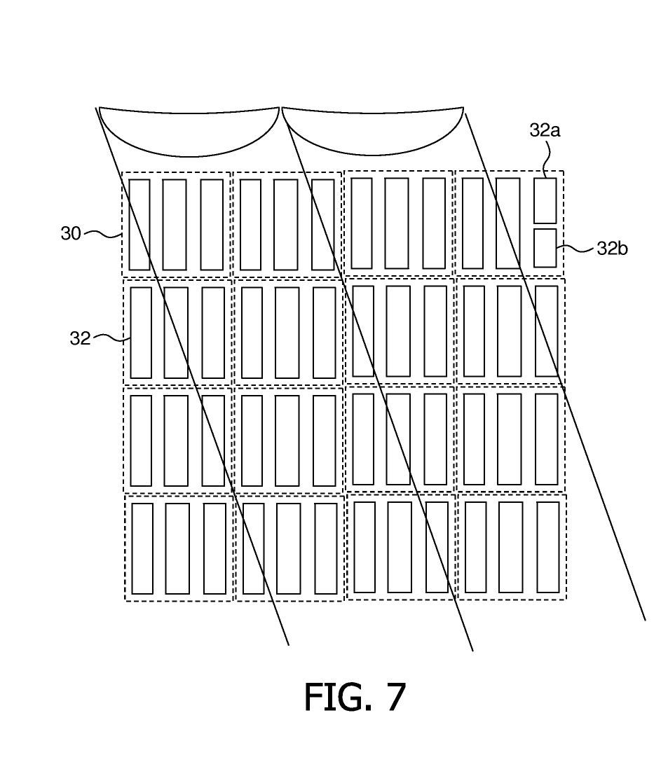

A first approach is shown by the pixel represented in FIG. 6. Each pixel (with six sub-pixels) 60 to 65 is addressed by two row lines 66 and 67 and three column lines 68, 69 and 70. The row lines do not connect to all sub-pixels in a row, but instead connect to alternate sub-pixels from one row and alternate sub-pixels from the other row. This is shown in FIG. 6, and means that each row line controls two sub-pixels from one of the two rows and one from the other, i.e. the patterns shown in FIG. 5.

Instead of using interleaved checkerboard patterns as shown, the alternating pixel rows can be addressed at different times. Again, the same column conductors can be used to address the different sub-pixels at different times. There are many other possibilities, even at pixel level (i.e. with different pixels being divided into the two groups of sub-pixels differently).

Although the update of the sub-frames is separated by half a sub-frame, the holding time of each frame can be a full frame period so as to avoid flicker and light loss.

In the examples above, the pixel structure allows a pixel area to be driven as two pixels—i.e. there are six sub-pixels in each pixel area, so that two groups of three sub-pixels can be driven at different time. An alternative is to add switchable blocking elements which would alternately block half of the sub-pixels. In this case, the display can have for example three sub-pixels per pixel and each sub pixel is half covered when it is driven.

The lens arrangement used preferably has a low crosstalk configuration and the underlying pixel a banding friendly shape. Banding is a phenomenon where the lens images the black matrix of the display panel. Low crosstalk lenses are typically those with slant tan (angle)=⅓ or 0 and an integer horizontal width. When the sub-pixels are spatially alternated in checkerboard (as shown), the width/pitch of the lens should be an odd integer number of sub-pixels.

An example of preferred configuration is a 5 view system, with slant (tan (slang angle)=⅓, and lens pitch of 5 sub-pixels. This is shown in FIG. 7. The lens and sub-pixel arrangement gives a 10 view system while retaining a perfectly square 3D pixel grid. A 3D pixel is the picture element of the stereoscopic image displayed as observed by a viewer. It is distinct from the 2D pixels and their grid. Thus, each pixel area (shown as dotted squares 30 in FIG. 7) can be considered to comprise 6 sub-pixels (each rectangular pixel area 32 has a top sub-pixel and a bottom sub-pixel as shown only for top sub-pixel 32a and bottom sub-pixel 32b). There are 10 different relative positions of the sub-pixels with respect to the lens, giving rise to the 10 views, and each pixel has 6 sub-pixels at six different relative positions. Thus, each pixel area 30 can be addressed twice in sequence. In the same way as described above, this provides two display operations at the full resolution (i.e. a full color pixel is defined within each area 30).

The system explained above uses two sub-frame times. It is also possible to have a different number (n) of sub-frame times, by having 3n sub-pixels per pixel.

Some LCD designs using in-plane switching of the LC material allow a frame rate of 100 Hz. There is a trend towards using LC effects that enable an even faster LC response (e.g. the so-called optically compensated birefringence (OCB) effect), enabling a frame rate of for example 180 Hz.

The examples described above employ a liquid crystal display panel having, for example, a display sub-pixel pitch in the range 50 μm to 1000 μm. However, it will be apparent to those skilled in the art that alternative types of display panel may be employed, such as organic light emitting diode (OLED) or cathode ray tube (CRT) display devices.

The driving method of the invention can be implemented in the display controller, for example the controller 13 as shown in FIG. 1.

The manufacture and materials used to fabricate the display device have not been described in detail, as these will be conventional and well known to those skilled in the art.

The preferred example of controllable lens array has segmented row and column electrodes, but only segmented column electrodes are required to enable compatibility with multiple different views.

The description above relates to color displays, in which each pixel comprises three sub-pixels. However, a pixel can comprise a single pixel element for a monochrome display. In this case, a pixel with two sub pixels can be driven in the manner of the invention.

There are many different possible combinations of slant angle and lens pitch, to create different numbers of views.

A first example of an imaging arrangement for use in this type of display is a barrier, for example with slits that are sized and positioned in relation to the underlying pixels of the display. The viewer is able to perceive a 3D image if his/her head is at a fixed position. The barrier is positioned in front of the display panel and is designed so that light from the odd and even pixel columns is directed towards the left and right eye of the viewer.

A drawback of this type of two-view display design is that the viewer has to be at a fixed position, and can only move approximately 3 cm to the left or right. In a more preferred embodiment there are not two sub-pixel columns beneath each slit, but several. In this way, the viewer is allowed to move to the left and right and perceives a stereo image in his eyes all the time.

The barrier arrangement is simple to produce but is not light efficient.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

A high number of views mean the image resolution per view is reduced because the total number of available pixels has to be distributed among the views. In the case of an n-view 3D display with vertical lenticular lenses, the perceived resolution of each view along the horizontal direction will be reduced by a factor of n relative to the 2D case. In the vertical direction the resolution will remain the same. The use of a barrier or lenticular that is slanted can reduce this disparity between resolution in the horizontal and vertical direction. In that case, the resolution loss can be distributed evenly between the horizontal and vertical directions.

1. An autostereoscopic display comprising:
a display panel (3) having an array of pixels arranged in rows and columns, for producing a display output, each of the pixels comprising at least two sub-pixels,
an imaging arrangement (9) for directing the output from different sub-pixels to different spatial positions so as to enable an autostereoscopic view of the display output; and
a controller for controlling the output from the sub-pixels such that:
in a frame time comprising a first and second sub-frame time, the display panel (3) produces a frame of the display output,
wherein in a first sub-frame time, a first set of sub-pixels provides a first sub-frame, in a second sub-frame time, a second set of pixels different from the first set of pixels provides a second sub-frame.
wherein the first and second sub-frames together provide the frame with the information for enabling its autostereoscopic view.

2. An autostereoscopic display as claimed in claim 1, wherein the first and second sub-frames each include information for the left and right eyes of a viewer.

3. An autostereoscopic display as claimed in claim 1, wherein the first and the second sub-frames together define a complete frame.

4. An autostereoscopic display as claimed in claim 1, wherein the first and second sets of sub-pixels together comprise all the sub-pixels (5), and no sub-pixel is in both of the first and second sets of sub-pixels.

5. An autostereoscopic display as claimed in claim 1, wherein the sub-pixels are grouped into color pixels, each color pixel comprising two red sub-pixels, two green sub-pixels and two blue sub-pixels.

6. An autostereoscopic display as claimed in claim 1, wherein the frames are provided at a frame rate of 100 Hz or more.

7. An autostereoscopic display as claimed in claim 1, wherein the imaging arrangement comprises an array of lenticulars for directing the output from different sub-pixels to the different spatial positions.

8. An autostereoscopic display as claimed in claim 7, wherein the pitch between lenticulars corresponds to the spacing of a row five neighboring sub-pixels along a row of sub-pixels.

9. A device as claimed in claim 7, wherein the lenticulars have an elongated semi-cylindrical shape and are oriented such that their elongate axis is slanted with respect to the column direction of the pixels.

10. A device as claimed in claim 1, wherein the sub-pixels are individually addressable and are emissive, transmissive, refractive and/or diffractive sub-pixels.

11. A device as claimed in claim 10, wherein the display panel is any one of a liquid crystal display panel, a plasma display panel and a light emitting diode display panel.

12. A method for controlling an autostereoscopic display device comprising:
a display panel (3) having an array of pixels (5) for producing a display output, the pixels being arranged in rows and columns and each of the pixels comprising at least two sub-pixels,
an imaging arrangement (9) for directing the output from different sub-pixels to different spatial positions so as to enable stereoscopic view of the display output, and
the method comprising the steps of:
in a frame time comprising a first and second sub-frame time, displaying a frame of the display output,
in a first sub-frame time, controlling a first set of sub-pixels to provide a first sub-frame,
in a second sub-frame time, controlling a second set of sub-pixels different from the first set of sub-pixels to provide a second sub-frame,
wherein the first and second sub-frames together provide the frame with the information for enabling its stereoscopic view.

13. A method as claimed in claim 12, wherein each of the first and second sub-frames of the display output include information for both eyes of the viewer simultaneously.

14. A method as claimed in claim 12, wherein the first sub-frame time and the second sub frame time together define a complete frame time, the frame of the display output provides one set of autostereoscopic images and wherein the first and second sets of sub-pixels together comprise all the sub-pixels while no sub-pixel is in both the first set and the second set.

15. A computer program comprising computer program code means adapted to perform all the steps of claim 12 when said program is run on a computer.
